(19) United States
(12) Patent Application Publication
(10) Pub. No.: US 2001/0014715 A1
(43) Pub. Date: Aug. 16, 2001

(54) Aqueous barrier coating compositions containing polyurethane dispersions

(76) Inventors: Harald Blum, Leverkusen (DE); Jurgen Meixner, Krefeld (DE); Heino Muller, Leverkusen (DE); Joachim Petzoldt, Monheim (DE)

Correspondence Address: BAYER CORPORATION, PATENT DEPARTMENT, 100 BAYER ROAD, PITTSBURGH, PA, 15205, US

(21) Appl. No.: 09/770,027

(22) Filed: Jan. 25, 2001

(30) Foreign Application Priority Data
Feb. 3, 2000 (DE) 10004723.8

(51) Int. Cl. C08K 3/20

(52) U.S. Cl. 524/591

(57) ABSTRACT

The present invention relates to aqueous polyurethane dispersions wherein the polyurethanes are reaction products of

A) at least difunctional polyols having a molecular weight of 500 to 6000,

B) at least difunctional low molecular weight alcohols,

C) di- and/or trifunctional isocyanates and

D) compounds with an acid group and one or two hydroxy- and/or primary or secondary amino groups in an amount sufficient to provide an acid number, based on resin solids, of <25 mg KOH/g of substance,

wherein

i) the neutralizing agent is added in an amount sufficient to neutralize 40 to 105% of the acid groups and an amount sufficient to neutralize at least 40% of the acid groups is added prior to the chain extension reaction,

ii) at least 1 wt. % of components A) and B), based on the total weight of components A) to D), are tri- or higher-functional compounds and

iii) the polyurethane contains 1 to 4 wt. % of the urea groups formed by the reaction of water and isocyanate groups.

The present invention also relates to a process for preparing these polyurethane dispersions and to coating compositions containing these polyurethane dispersions.

### BACKGROUND OF THE INVENTION

1. Field of the Invention

The invention relates to novel polyurethane dispersions, a process for their production and their use in aqueous binders for rapidly drying coating compositions in automotive painting.

2. Description of the Prior Art

In automotive production line painting a multi-coat construction has become standard. It is carried out on an increasing scale by means of aqueous coating compositions. Because of the particular problems of water as the dispersant or solvent, the drying of these coating compositions has to take place at relatively high temperatures and/or for relatively long periods to achieve optimum coating properties. Modem coating compositions, however, also increasingly have to be highly cost-effective. An important aim is to apply the coating construction in the initial automotive painting stage in individual steps that are as few and as cheap as possible and above all follow each other in quick succession. High drying temperatures, long solvent evaporation times and long drying times make this requirement difficult to achieve.

In the conventional coating of automobiles a coat to protect against impact from flying stones and a filler coat or a combination of both (“filler protecting against impact from flying stones”) is/are initially applied to a metal surface primed by cathodic electrophoretic coating (CEC). After that a pigmented base coat and then a clear top coat is applied or, alternatively, a pigmented top coat is applied.

The filler coat protecting against impact from flying stones serves to smooth out unevenness in the surface and produces a good resistance to impact from flying stones through its high elasticity and deformability. Polyesters and polyurethanes as well as polyisocyanate or melamine crosslinking agents have previously been used for this coat. The filler protecting against impact from flying stones is stoved prior to the application of the base coat and the clear lacquer or top coat. This is necessary to improve the “take” of the top coat and to seal any defects still present in the filler coat. Further stoving then takes place after the application of the clear lacquer or top coat. This process has the disadvantage that two expensive stoving operations are required. Known coatings that dry rapidly without a stoving operation, such as those containing polyacrylates, do not exhibit the required resistance to impact from flying stones, since on curing they lead to films with inadequate mechanical properties.

An object of the present invention is to provide a binder for a barrier coat that protects against impact from flying stones and additionally dries very rapidly such that the resulting coating has very good water-resistance and is resistant to being dissolved by the subsequently applied base or top coat. It is an additional object of the present invention that the adhesion or inter-layer adhesion should also be exceptional, in order to ensure an optimum multi-layer coating. It is a further object of the present invention for the binder to provide a light-fast, weather-resistant coating for those instances when moderately opaque top or base coats are used or when a pigmented top or base coat is completely omitted. It is a final object of the present invention for the binder to have outstanding stability, in particular viscosity stability, when formulated in coating compositions and the ability to be repaired directly on the coating line.

A proposed solution for coatings resistant to impact from flying stones and/or filler coats based on aqueous binders is described in EP-A-0 330 139. The claimed dispersions of acid-functional polyesters have only a limited shelf life, as they are subject to a rapid chemical decomposition by the splitting of ester bonds (e.g. Jones, T. E.; McCarthy, J. M., J. Coatings Technol. 76 (844), p. 57 (1995)).

EP-A-0 498 156 describes polyester dispersions containing urethane groups, which are very suitable for producing intermediate primer coats protecting against impact from flying stones or stoving fillers with high resistance to impact from flying stones. In order to achieve these superior properties, however, high curing temperatures or long stoving times are required.

DE-A-3,936,794 describes polyurethane dispersions containing carbonate groups and their use in automotive painting, e.g. for base coats. Stoving conditions of approx. 140° C. and, in cases of repair on the line, curing at approx. 80° C. are mentioned. Important requirements for these dispersions are e.g. adhesion, weathering resistance and resistance to condensation also at 80° C. drying.

DE-A-4,438,504 describes coating compositions based on water-thinnable polyurethane resins with a number average molecular weight (Mn) of 4000 to 25000 g/mole. The thinnest possible coatings for fillers and intermediate primer coats that resist impact from flying stones can be produced.

There is nevertheless still a need for additionally improved products, which are capable of meeting continually increasing requirements and which permit varied applications. In addition, a very rapid natural drying, a rapidly achievable, very good water resistance and a very high hardness/elasticity level are particularly required, something which cannot always be achieved with the products according to the prior art.

Surprisingly it has now been found that particular high molecular-weight, solvent-free polyurethane dispersions based on reaction products of polyols, at least dihydroxy-functional low molecular weight compounds, hydrophilic compounds and at least difunctional isocyanates, wherein the polyurethane dispersions have a relatively high content of carboxylate groups and contain isolated urea groups, are particularly well suited to meeting these requirements of a barrier coat with a protective function against impact from flying stones. It was also found that such products can be manufactured by a very simple, and in particular low cost process, by a single-stage, rapidly proceeding urethanization reaction, dispersion step and then a simultaneously occurring solvent distillation and chain extension step. It is possible in this way to produce high-quality, environmentally friendly products at low cost.

### SUMMARY OF THE INVENTION

The present invention relates to aqueous polyurethane dispersions wherein the polyurethanes are reaction products of

A) at least difunctional polyols having a molecular weight of 500 to 6000,

B) at least difunctional low molecular weight alcohols,

C) di- and/or trifunctional isocyanates and

D) compounds with an acid group and one or two hydroxy- and/or primary or secondary amino groups in an amount sufficient to provide an acid number, based on resin solids, of <25 mg KOH/g of substance,

wherein

i) the neutralizing agent is added in an amount sufficient to neutralize 40 to 105% of the acid groups and an amount sufficient to neutralize at least 60% of the acid groups is added prior to the chain extension reaction,

ii) at least 1 wt. % of components A) and B), based on the total weight of components A) to D), are tri- or higher-functional compounds and

iii) the polyurethane contains 1 to 4 wt. % of the urea groups set forth in brackets in the following formula:

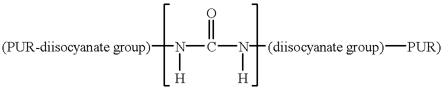

The present invention also relates to a process for preparing these polyurethane dispersions which comprises forming an isocyanate- and acid-functional polyurethane by reacting

I) A) an at least difunctional polyol having a number average molecular weight of 500 to 6000,

B) an at least difunctional low molecular weight alcohol,

C) a di- and/or trifunctional isocyanate and

D) a compounds having at least one acid group and one or two hydroxy- and/or primary or secondary amino groups in an amount sufficient to provide an acid number, based on resin solids, of <25 mg KOH/g of substance,

II) subsequently adding a neutralizing agent in an amount sufficient to neutralize 40 to 105% of the acid groups and dispersing the prepolymer in water,

III) optionally adding additional neutralizing agent in an amount sufficient to neutralize 105% of the acid groups,

IV) subsequently chain extending said prepolymer in water at 25° C. to 75° C. and

V) removing any organic solvent during or after formation of the dispersion or during or after the chain extension reaction until the amount of organic solvent is less than 5%, based on the weight of the aqueous dispersion.

The present invention additionally relates to coating compositions containing these polyurethane dispersions.

### DETAILED DESCRIPTION OF THE INVENTION

Suitable components A) include at least difunctional polyesters, polyethers, polyether polyamines, polycarbonates and polyester amides having a number average molecular weight of 500 to 6000. Examples include polyesters prepared from dicarboxylic acids or their anhydrides, e.g. adipic acid, succinic acid, phthalic acid anhydride, isophthalic acid, terephthalic acid, suberic acid, azelaic acid, sebacic acid, tetrahydrophthalic acid, maleic anhydride, dimeric fatty acids and diols, e.g., ethylene glycol, propylene glycol, 1,3-propanediol, diethylene glycol, triethylene glycol, 1,4-butanediol, 1,6-hexanediol, trimethylpentanediol, 1,4-cyclo-hexanediol, 1,4-cyclohexane-dimethanol, neopentyl glycol and 1,8-octanediol. The polyesters can also be prepared from mono-, tri- or tetrafunctional raw materials, such as 2-ethylhexanoic acid, benzoic acid, soya bean oil fatty acid, oleic acid, stearic fatty acid, sunflower oil fatty acid, trimellitic anhydride, trimethylol propane, glycerine and pentaerythritol.

Also suitable are polyesters made from lactones, in particular ε-caprolactone; polycarbonates, available by reacting for example of the diols mentioned above with diaryl or dialkyl carbonates or phosgene; and castor oil. Also suitable are polyethers, such as can be obtained by the polymerization of propylene oxide and/or tetrahydrofuran, optionally with the additional use of small amounts of ethylene oxide and/or styrene oxide wherein diols, triols, water or amines are used as starter molecule(s).

Preferred components A) are difunctional polyesters having a number average molecular weight of 840 to 2600, preferably 1700 to 2100, which are prepared from aliphatic raw materials, such as adipic acid, maleic anhydride, hexanediol, neopentyl glycol, ethylene glycol, propylene glycol and diethylene glycol, more preferably adipic acid, hexanediol and neopentyl glycol.

Preferred components A) are also aliphatic polycarbonate diols or polyester carbonate diols having a number average molecular weight of 840 to 2600.

In a preferred embodiment component A) contains a mixture of 20 to 80 wt. % of an aliphatic polyester diol with a number average molecular weight of 840 to 2100 and 20 to 80 wt. % of an aliphatic polycarbonate diol or polyester carbonate diol with a number average molecular weight of 1000 to 2100.

It was found that these mixtures produce particularly good properties with respect to rapid drying of the dispersion, combined with very good water resistance and a high level of protection of the barrier coat against impact from flying stones. If polyester diols are used alone, it is advantageous for good water resistance and resistance to hydrolysis to select particular polyester diols, e.g. those based on adipic acid, hexanediol, neopentyl glycol and having a molecular weight of 1700 to 2100. The use of polycarbonate diols alone can lead to problems in the film appearance, e.g. due to non-optimal flow, and in unfavorable conditions also to non-optimal inter-layer adhesion.

Suitable low molecular weight components B) have a number average molecular weight of less than 500, preferably 62 to 400, and include ethylene glycol, 1,4-butanediol, 1,6-hexanediol, neopentyl glycol, trimethylol propane, glycerine, pentaerythritol, trimethyl-pentanediol, propylene glycol, 1,3-propanediol, 1,4-cyclohexadimethanol, or their reaction products with ethylene and/or propylene oxide. Preferably component B) is a tri- or higher-functional low molecular weight alcohol such as trimethylol propane, glycerine, pentaerythritol or their reaction products with 1 to 6 moles of ethylene and/or propylene oxide. Especially preferred is the use of trifunctional alcohols such as trimethylol propane or glycerin in an amount of 0.5 to 4.0, preferably 1.0 to 3.0 wt. %.

Suitable components C) include di- and/or trifunctional aliphatic isocyanates such as hexamethylene diisocyanate, butane diisocyanate, isophorone diisocyanate, 1-methyl-2,4- and/or 2,6-diisocyanatocyclo-hexane, norbornane diisocyanate, xylylene diisocyanate, tetramethyl xylylene diisocyanate, hexahydro xylylene diisocyanate, nonane triisocyanate and 4,4′-diisocyanatodicyclohexylmethane. Also suitable is the joint use of aromatic isocyanates such as 2,4- and/or 2,6-diisocyanatotoluene or 4,4′-diisocyanato-diphenylmethane, as well as higher molecular weight or oligomeric polyisocyanates having a number average molecular weight of 336 to 1500 and based on the above-mentioned aliphatic isocyanates.

Preferably 4,4′-diisocyanatodicyclohexylmethane, isophorone diisocyanate, hexa-methylene diisocyanate and/or 1-methyl-2,4- and/or 2,6-diisocyanato-cyclohexane are used. Especially preferred are isophorone diisocyanate and/or hexamethylene diisocyanate or mixtures of 4,4′-diisocyanato-dicyclohexylmethane with isophorone diisocyanate or hexamethylene diisocyanate. The use of preferred components C) results in the production of high quality polyurethane dispersions for barrier coats having an exceptional level of protection against impact from flying stones.

Component D) is selected from (potentially) ionic compounds having at least one acid group and at least one hydroxyl and/or amino group, which is reactive to isocyanate groups. Preferably, these compounds contain at least one carboxylic acid group and one or two hydroxyl and/or amino groups. Suitable acids include 2,2-bis(hydroxymethyl)alkanecarboxylic acids (such as dimethylol acetic acid, 2,2-dimethylol propionic acid, 2,2-dimethylol butyric acid or 2,2-dimethylol-pentane acid), dihydroxy-succinic acid, hydroxypivalic acid or mixtures of such acids. Preferably dimethylol propionic acid and/or hydroxypivalic acid is used as component D). Also suitable, although less preferred, is the use of sulfonic acid diols optionally containing ether groups as described in U.S. Pat. No. 4,108,814. The free acid groups represent the above-mentioned “potentially ionic” groups, while the salt groups obtained by neutralizing the acid groups with neutralizing agents are “ionic” groups.

Component D) is used in amounts sufficient to provide an acid number, based on resin solids, <25, preferably <20 mg/KOH g of substance.

It was found that despite the relatively high acid number or the resulting high content of salt groups, e.g. carboxylate groups, dispersions are obtained which permit the production of barrier coats with very rapidly achieved water resistance. Despite the high salt group content and the high molecular weight of the dispersions according to the invention it is possible to formulate paints for barrier coats with a high level mechanical properties, e.g. hardness/elasticity, and an excellent level of protection against impact from flying stones. The dispersions also possess a solids content of 50 wt. % or more and may be consistently applied.

In addition to components A), B), C), D), the dispersions may also be prepared from less than 4 wt. % of component E), which is selected from nonionic-hydrophilic polyethers containing one or two isocyanate-reactive groups, preferably hydroxyl groups, and preferably having a number-average molecular weight of 350 to 2500.

The aqueous polyurethane dispersions according to the invention are preferably reaction products of

A) 50 to 80 wt. % of at least difunctional aliphatic polyester, polyester carbonate and/or polycarbonate polyols having a molecular weight of 840 to 2600,

B) 0.5 to 4 wt. % of at least difunctional, low molecular weight alcohols having a molecular weight of 62 to 400,

C) 18 to 38 wt. % of di- and/or trifunctional isocyanates,

D) 2.5 to 6 wt. % of dimethylol propionic acid, dimethylol butyric acid and/or hydroxypivalic acid, and

E) less than 4 wt. % of nonionic-hydrophilic, monofunctional polyethers with molecular weights of 350 to 2500,

wherein

i) the neutralizing agent is added in an amount sufficient to neutralize 60 to 105% of the acid groups and an amount sufficient to neutralize at least 60% of the acid groups is added prior to the chain extension reaction,

ii) at least 1 wt. % of components A) and B), based on the total weight of components A) to D), are tri- or higher-functional compounds and

iii) the polyurethane contains 1 to 4, preferably 1.75 to 3.25 wt. % of the urea groups set forth in brackets in formula I.

The calculation of the urea group content is based on the assumption that half of the isocyanate groups of the polyurethane prepolymer react with water to form amino groups (accompanied by CO₂ formation), which then react with the other half of the isocyanate groups to form isolated monourea bridges, which increases the molecular weight.

Especially preferred aqueous polyurethane dispersions according to the invention are reaction products of

A) 55 to 75 wt. % of a mixture of 20 to 80 wt. % of an aliphatic polyester diol having a molecular weight of 840 to 2100 and 20 to 80 wt. % of an aliphatic polycarbonate diol or polyester carbonate diol having a molecular weight of 1000 to 2100,

B) 1 to 3 wt. % of a trifunctional low molecular weight alcohol, preferably trimethylol propane or glycerine,

C) 20 to 35 wt. % of isophorone diisocyanate and/or hexamethylene diisocyanate, or a mixture of 4,4′-diisocyanatodicyclohexylmethane with isophorone diisocyanate or hexamethylene diisocyanate and

D) 3.5 to 4.9 wt. % of dimethylol propionic acid.

The reaction of hydroxy-functional components A), B), D) and optionally E) with the isocyanate component C) takes place in known manner in one or more stages, wherein the quantitative ratios of the reactants are selected such that the equivalent ratio of NCO:OH groups is 2.5:1 to 1.2:1, preferably 1.7:1 to 1.4:1. The reaction can be carried out with the addition of small amounts of catalysts, such as dibutyltin dilaurate, tin-2-octoate, dibutyltin oxide or diazabicyclononane.

In order to prevent viscosity, stirring, mixing and heat dissipation problems, the reaction is preferably carried out in a 35 to 97% organic solution, more preferably in a 55 to 75% acetone solution.

A preferred process for preparing the polyurethane dispersion of the invention comprises forming an isocyanate- and acid-functional polyurethane by reacting

I) A) an at least difunctional polyol having a number average molecular weight of 500 to 6000,

B) an at least difunctional low molecular weight alcohol, and

D) a compounds having at least one acid group and one or two hydroxy- and/or primary or secondary amino groups in an amount sufficient to provide an acid number, based on resin solids, of <25 mg KOH/g of substance, in the presence of a neutralizing agent in an amount sufficient to neutralize 40 to 105% of the acid groups

with

C) a di- and/or trifunctional isocyanate, and

II) dispersing the resulting prepolymer in water,

III) optionally adding additional neutralizing agent in an amount sufficient to neutralize 105% of the acid groups,

IV) subsequently chain extending said prepolymer in water at 25° C. to 75° C. and

V) removing any organic solvent during or after formation of the dispersion or during or after the chain extension reaction until the amount of organic solvent is less then 5%, based on the weight of the aqueous dispersion.

Prior to the dispersing of the organically dissolved, isocyanate-functional polyurethane prepolymer, or else already prior to the reacting of components A), B), D), and optionally E) with the isocyanate-functional component C), neutralizing agent is added in an amount sufficient to neutralize 40% to 105%, preferably 50% to 105% of the acid groups. It is also possible to add the neutralizing agent to the dispersing water.

Preferred neutralizing agents include triethylamine, N-methyl morpholine, dimethyl-isopropylamine, diisopropylaminoethanol, dimethyl ethanolamine and dimethyl isopropanolamine. Mixtures of different neutralizing agents can also be used. Ammonia is also suitable as a neutralizing agent in certain cases. Particularly preferred is diethyl isopropylamine, optionally in admixture with other amines.

After the dispersing the polyurethane prepolymer in water, it is stirred until all the isocyanate groups have fully reacted with water resulting in chain extension via isolated urea groups. Further neutralizing agent can also optionally be added at a later stage, provided that the degree of neutralization is not more than 105%.

The solvents used to produce the polyurethane prepolymer can be partially or preferably completely separated out of the dispersion by distillation. Preferably, the dispersions according to the invention contain less than 2.5 wt. % and more preferably do not contain organic solvent.

The distillation takes place such that no neutralizing agent is distilled off at the same time. Should this happen, however, due to the selection of unfavorable distillation conditions, the corresponding amount of neutralizing agent is then added to the dispersion again.

During the chain extension of the isocyanate-functional polyurethane prepolymer in water other known mono-, di- or trifunctional chain extension or chain termination agents can optionally be added to react with up to 40% of the isocyanate groups present. They can optionally also contain ionic groups, acid groups or hydroxyl groups. Preferably, however, chain extension is carried out exclusively via the isocyanate-water reaction.

The dispersions according to the invention have particle diameters, determined e.g. by LKS measurements, of 20 to 600, preferably of 50 to 150 nm.

The solids content of the dispersions is at least 30%, preferably at least 35%. The pH value of the dispersion is less than 8.5, preferably below 7.8. The number average molecular weight (Mn) of the dispersion is >20,000, preferably >30,000 and more preferably >40,000 g/mole (as determined by gel permeation chromatography). In a particular embodiment a portion of the dispersion contains very high molecular weight portions, which are no longer completely soluble in organic solvents and for which molecular weight cannot be determined.

The products according to the invention are suitable for coating any substrates, in particular wood, ceramics, stone, concrete, bitumen, hard fiber, glass, china, plastics and metal undersurfaces. In addition, they can be used as a finish or dressing in textile or leather coating.

The preferred field of use is the initial coating of vehicles, in particular as a barrier coat to obtain high level of protection against impact from flying stones and exceptional water resistance.

The dispersions according to the invention can also contain known additives, e.g., inorganic or organic pigments, fillers (such as carbon black, silica, talc, chalk, siliceous earth and kaolin), glass in the form of powder or fibers, and cellulose or cellulose acetate butyrate. The dispersions can also contain crosslinking agents such as blocked polyisocyanates, polyisocyanates, melamine resins, urea resins, urea-aldehyde resins, carbodiimides, carbamates, tris(alkoxycarbonylamino)-triazines and carbamate-modified amino-crosslinking resins. The crosslinking agents can be used in water-dispersible or in non-water-dispersible (hydrophobic) form.

Examples of suitable polyisocyanates, which may be blocked, include cycloaliphatic or aliphatic polyisocyanates such as hexamethylene diisocyanate (HDI), 1-iso-cyanato-3,3,5-trimethyl-5-isocyanatomethylcyclo-hexane (isophorone diisocyanate, IPDI), methylene-bis-(4-isocyanato-cyclohexane) and tetramethyl xylylene diisocyanate (TMXDI). Preferred are polyisocyanates that contain heteroatoms in the group containing the isocyanate groups. Examples are polyisocyanates containing carbodiimide groups, allophanate groups, isocyanurate groups, urethane groups and biuret groups.

Especially preferred are the known lacquer polyisocyanates containing biuret, isocyanurate or uretdione groups and prepared from the above-mentioned monomericu polyisocyanates, in particular hexamethylene diisocyanate or isophorone diisocyanate. Also suitable are lacquer polyisocyanates containing urethane groups and obtained by reacting an excess of IPDI or TDI with simple polyvalent alcohols having a molecular weight of 62 to 300, preferably trimethylol propane or glycerine. Any mixtures of the above-mentioned polyisocyanates can also be used to produce the products according to the invention.

Also suitable as polyisocyanates are the known prepolymers containing terminal isocyanate groups and obtained in particular by reacting the above-mentioned monomeric polyisocyanates, in particular diisocyanates, with less than equivalent amounts of organic compounds having at least two isocyanate-reactive groups, preferably the polyols previously described.

Suitable blocking agents for preparing the blocked polyisocyanates include dimethyl malonate, diethyl malonate, ethyl acetoacetate, caprolactam, secondary aliphatic amines, butanone oxime and 3,5-dimethyl pyrazole.

The blocked polyisocyanates can be used in hydrophobic form, wherein the transfer into the aqueous dispersion can be obtained, e.g., by mixing and joint dispersion with the polyurethane prepolymer. The polyurethane dispersion according to the invention can also be used as a polymeric emulsifier for non-water-dispersible crosslinking agents. It is also possible to add to the polyurethane dispersion according to the invention a hydrophilic blocked polyisocyanate that is water-dispersible or already present in water-dispersible form. Hydrophilic blocked polyisocyanates are known and described, e.g., in EP-A-0 566 953 (U.S. Pat. No. 5,455,297, herein incorporated by reference).

Preferred crosslinking agents are reactive amino-crosslinking resins or melamine resins such as Cymel 328 (Cytec); trisalkoxycarbonyl-aminotriazines such as TACT (Cytec); and/or reactive malonic ester-blocked polyisocyanate crosslinking agents and/or urethanized melamine resins.

The polyurethane dispersions according to the invention can be combined with other binders. Preferred is the combination with water-soluble or water insoluble melamine resins as well as water-emulsifiable or water dispersible polyester resins or polyester-polyurethane resins.

The handling of the dispersion for producing coatings can take place according to any method known in the art, for example by brushing, pouring, spraying, dipping, rolling or knife coating.

The dispersions according to the invention are suitable for producing coating compositions, sealants and adhesives.

The drying of the products obtained by various application techniques can take place at room temperature or at elevated temperatures of up to 200° C., preferably at 60 to 150° C.

In the preferred use according to the invention as a coating composition which dries naturally and very rapidly at low temperatures in initial vehicle coating as a barrier coat with a high level of protection against impact from flying stones, the application preferably takes place by spraying and drying preferably for 5 to 10 minutes at 50 to 80° C.

The dry film coating thickness is preferably between 15 and 50 μm, but coatings with higher coating thicknesses are possible. The coating can be adjusted to be highly flexible, but also hard, depending upon the requirements. After drying the barrier coat is sandable and very easy to overcoat. After overcoating with a base coat/clear coat or a pigmented top coat, a common stoving operation then takes place, e.g. for 20 to 25 minutes at 120 to 160° C.

The resulting coating has optical and mechanical properties that are comparable to or better than a multi-layer coating in which, instead of the barrier coat, a filler is applied in known manner at a 35 to 45 μm dry film coating thickness and individually stoved for 20 to 25 minutes at 135 to 165° C., and subsequently a base coat/clear coat or pigmented top coat is applied.

The dispersions according to the invention can be mixed with other ionic or nonionic dispersions or aqueous dispersions, e.g., with polyester-polyvinyl acetate, polyethylene, polystyrene, polybutadiene, polyurethane, polyvinyl chloride, polyester-polyacrylate, polyacrylate and copolymer dispersions or solutions. The addition of known external emulsifiers, which are preferably ionic, is also possible.

Preferred is the use of water-soluble or water-dispersible polyesters, polyester-polyurethanes, polyester-polyacrylates as well as other polyurethane dispersions, in particular of polyurethane dispersions with rapid natural drying and high rigid segment contents.

The coating compositions for barrier coats contain in addition to the known additives used in automotive coatings and optionally water for adjusting the spraying consistency

a) 30 to 90, preferably 45 to 75 wt. % of the polyurethane dispersions according to the invention,

b) 0 to 20, preferably 1 to 10 wt. % of crosslinking agents,

c) 5 to 70, preferably 10 to 44 wt. % of pigments and/or fillers and

d) 0 to 65, preferably 10 to 44 wt. % of other binders, preferably aqueous polyester or polyester-polyurethane solutions or dispersions.

The coating compositions for barrier coats have solids contents of at least 45, preferably at least 50% with application consistency and also exhibit a very good stability to viscosity during storage in the presence of highly reactive crosslinking agents for stoving compositions, e.g. melamine resins.

At the same time the barrier coats prepared from the dispersions according to the invention have an outstanding resistance to impact from flying stones and very good adhesion and intercoat adhesion.

The polyurethane dispersions according to the invention can also be used to produce reactive stoving compositions curable at low temperatures, in particular stoving fillers. They are preferably combined with reactive crosslinking resins and optionally other polymers such that coatings are obtained at 90 to 120° C. optionally with the additional use of suitable catalysts and known pigments and additives.

The invention is further illustrated but is not intended to be limited by the following examples in which all parts and percentages are by weight unless otherwise specified.

### EXAMPLES

### Example 1

(According to the Invention)

144 g of an aliphatic polycarbonate diol (Desmophen 2020, Bayer AG, molecular weight 2000), 108 g of a polyester diol based on adipic acid, hexane diol and neopentyl glycol (molecular weight 2000, molar ratio of glycols 65:35) and 17.6 g of dimethylpropionic acid were weighed under a nitrogen atmosphere into a dry 2 l reaction vessel having stirring, cooling and heating equipment and heated to 65° C. 6.0 g of trimethylol propane, 200 g of acetone, 59.5 g of isophorone diisocyanate and 39.0 g of hexemethylene diisocyanate were then added and heated to reflux temperature. Heating was carried out until the isocyanate content was at or below the theoretical isocyanate value. After cooling to 60° C., 10.0 g of triethylamine (degree of neutralization, i.e. percentage of the carboxyl groups converted into the salt form, was 75%) and thereafter 550 g of distilled water were added. Stirring was carried out at 40 to 50° C. until free isocyanate groups were no longer detected. The acetone was then removed by distillation. A finely divided dispersion 1) having a solids content of 40%, a pH of 7.3 and a viscosity of approx. 200 mPa.s/23° C. was obtained.

### Example 2

(Comparison)

A polyester dispersion containing urethane groups was prepared according to EP-A-0 498 156 (U.S. Pat. No. 5,280,062), Example 2; solids content approx. 41%, viscosity approx. 1000 mPa.s/23° C.

### Application Example 3

(According to the Invention)

Production of a Barrier Coat:

A paint for a barrier coat 3) was produced from 117 g of pigment paste A), 182 g of dispersion 1), 9.8 g of an amino-crosslinking resin (Cymel 328, Cytec) and 10 g of distilled water. The coating composition had a pH of 7.6, a solids content of 52% and a flow time in ISO 5 cup of 21 seconds. After storage for 14 days at room temperature the viscosity of the coating composition had increased only slightly (24 seconds).

Pigment Paste A)

Pigment paste A) was produced from the following raw materials by grinding on a pearl mill: 42.2 g of a water dispersible polyester resin (Bayhydrol D270, dissolved 70% in organic solvents, Bayer), 82.4 g distilled water, 6 g of a 10% aqueous solution of dimethyl ethanolamine, 5.4 g of a 50% solution of a wetting agent (Surfynol 104, Air Products) in NMP, 5.4 g of an additive (Additol XW 395), 108.2 g of titanium dioxide (Bayertitan R-FD, Bayer), 1.2 g of iron oxide (Bayferrox 303T, Bayer), 108.9 g of an additive (Blanc fixe micro, Sachtleben), 26.6 g of talc (Talkum IT extra, Norwegian Talk) and 3.7 g of an additive (Aerosil R 972, Degussa).

The following multi-layer coating was applied to plates provided with a cathodic electrodeposition coating (CEC) and cured as follows:

a) barrier coat 3), 20 μm dry film thickness, 10 minutes 70° C. surface drying,

b) commercial base coat, black, 15 μm dry film thickness, 10 minutes 80° C. surface drying,

c) commercial medium solids clear lacquer, 40 μm dry film thickness, 25 minutes 145° C. stoving.

The following test results were obtained:

Appearance of the coating after application: OK

Intercoat adhesion barrier coat/top coat: (marks from 1 to 3, 1—very good, 3—poor): 1

Intercoat adhesion barrier coat/CEC: 1

Resistance to impact from flying stones (marks from 1 to 10, 1—very good, 10—very poor): 1

Testing in a repair case, i.e. base coat and clear coat were tested and cured once again in the multi-layer coating as described above (a total of 6 coats were applied on the plate):

Spalling of filler (marks from 1 to 7, 1—very good, 7—very poor): 1

Resistance to impact from flying stones: 1

In order to check the water resistance of the barrier coat, a coating with a 20 μm dry film thickness was applied and surface dried for 10 minutes at 70° C. The sensitivity to water swelling was then measured (marks 0 to 5, 0—no effect, 5—film dissolved): 1

In order to check the film hardness and the incipient solubility, a coating with a 20 μm dry film thickness was applied, dried for 5 minutes at 80° C. and stoved for 22 minutes at 145° C.

Film hardness: 58 pendulum seconds (König)

Solvent resistance (incipient solubility test with one minute of exposure to the following solvents: toluene, methoxypropyl acetate, ethyl acetate, acetone, rating 0 to 5, 0—unchanged, 5—dissolved): 2/2/2/2

Dispersion 1) meets all of the requirements needed for a barrier coat.

### Application Example 4

(Comparison)

As described in Example 3), a paint for a barrier coat was produced with the use of comparison dispersion 2) instead of dispersion 1), corresponding coatings were applied and cured, and the properties were tested.

The following test results were obtained:

Resin solids content: 51%, pH 7.5

Appearance of the coating after the application: Not OK, base coat did not adhere optimally to the barrier coat, it cracked.

A test for adhesion or protection against impact from flying stones in the paint construction was not possible.

Checking of the water resistance of the barrier coat after drying for 10 minutes at 70° C. drying: 5

Film hardness: 14 pendulum seconds (König)

Solvent resistance: 4/3/4/4

The comparison product was unsuitable as a barrier coat. Also, the solvent resistance and in particular the film hardness and the water resistance were inadequate.

### Example 5

(Comparison)

144 g of an aliphatic polycarbonate diol (Desmophen® 2020, Bayer AG, molecular weight 2000), 108 g of a polyester diol based on adipic acid, hexane diol and neopentyl glycol (molecular weight 2000) and 17.6 g of dimethylpropionic acid were weighed under a nitrogen atmosphere into a dry 2 l reaction vessel having stirring, cooling and heating equipment and heated to 65° C. 6.0 g of trimethylol propane, 200 g of acetone, 59.5 g of isophorone diisocyanate and 39.0 g of hexemethylene diisocyanate were then added and heated to reflux temperature. Heating was carried out until the isocyanate content was at or below the theoretical isocyanate value. After cooling to 60° C., 5.8 g of ethylene diamine diluted with 30 g water were added within 5 minutes, which corresponded to a degree of chain extension of approx. 60% (i.e. sufficient reactive amino groups in the form of a diamine were added to react with approx. 60% of the isocyanate groups still remaining). After stirring for 15 minutes 10.0 g triethylamine (degree of neutralization 75%) and thereafter 5500 g of distilled water were added. Stirring was carried out at 40 to 50° C. until free isocyanate groups were no longer detected. The acetone was then removed by distillation. After the addition of distilled water to reduce the viscosity, a finely divided dispersion 5) having a solids content of 32%, a pH of 7.8 and a viscosity of approx. 1100 mPa.s/23° C. was obtained.

### Application Example 6

(Comparison)

As described in Example 3), a coating composition for a barrier coat was produced with the use of comparison dispersion 5) instead of dispersion 1), coatings were applied and cured, and the properties were tested.

The following test results were obtained:

Resin solids content: 42%, pH 8.1

Appearance of the coating after the application: Not OK, bubbles in the clear lacquer. The solids content was too low; the use as a barrier coat led to unacceptable results.

### Example 7

(Comparison)

Polyurethane dispersion containing carbonate groups according to DE-A-2,926,794, Example A, approx. 40% solids content, viscosity approx. 50 mPa.s/23° C.

### Application Example 8

(Comparison)

As described in Example 3), a paint for a barrier coat was produced with the use of comparison dispersion 7) instead of dispersion 1), coatings were applied and cured, and the properties were tested.

The following test results were obtained:

Resin solids content: 52%, pH 7.5

Appearance of the coating after the application: OK to a limited extent. (Cracking of the base coat after drying for 5 minutes at 80° C.).

Checking of the water resistance of the barrier coat after drying for 10 minutes at 70° C.: 5

Film hardness: 34 pendulum seconds

Solvent resistance: 2/3/3/4

The comparison coating composition was unsuitable as a barrier coat, since neither a homogeneous multi-layer coating was achieved and the film hardness and water resistance was inadequate.

### Example 9

(According to the Invention)

420 g of a polyester diol based on adipic acid, hexane diol and neopentyl glycol (molecular weight 2000) and 29.2 g of dimethylolpropionic acid were weighed under nitrogen atmosphere into a dry 2 l reaction vessel having stirring, cooling and heating equipment and heated to 65° C. 10.0 g of trimethylol propane, 210 g of acetone, 114.9 g of isophorone diisocyanate and 52.9 g of hexemethylene diisocyanate were then added and heated to reflux temperature. Heating was carried out until the isocyanate content was at or below the theoretical isocyanate value. After cooling to 45° C., 20.6 g of diethyl isopropylamine (degree of neutralization 80%) and thereafter 970 g of distilled water were added. Stirring was carried out at 40 to 50° C. until free isocyanate groups were no longer detected. The acetone was then removed by distillation. A finely divided dispersion 9) having a solids content of 39%, a pH of 7.3 and a viscosity of approx. 800 mPa.s/23° C. was obtained.

### Example 10

(According to the Invention)

Production of a Barrier Coat:

A coating composition for a barrier coat 10) was produced from 117 g of a pigment paste A), 195 g of dispersion 9), 9.8 g of an amino-crosslinking resin (Cymel 328, Cytec) and 8 g of distilled water. The paint had a pH of 7.5, a solids content of 50.3% and a flow time in an ISO 5 cup of 21 seconds. After storage for 14 days at room temperature the viscosity of the coating composition increased only slightly (27 seconds).

The following test results were obtained from the multi-layer coating:

Appearance of the coating after application: OKIntercoat adhesion barrier coat/top

coat: 1

Intercoat adhesion barrier coat/CEC: 1

Resistance to impact from flying stones: 1

Testing in a repair case:

Spalling of the filler: 1

Resistance to impact from flying stones: 1

Water resistance of the barrier coat: 1

In order to check the film hardness and the incipient solubility, a coating with a 20 μm dry film thickness was applied, dried for 5 minutes at 80° C. and stoved for 22 minutes at 145° C.

Film hardness: 48 pendulum seconds (König)

Solvent resistance: 1/1/2/3

Dispersion 9) meets all the requirements for a barrier coat.

### Example 11

(According to the Invention)

160 g of an aliphatic polycarbonate diol (Desmopheno® 2020, Bayer AG, molecular weight 2000), 120 g of a polyester diol based on adipic acid, hexane diol and neopentyl glycol (molecular weight 2000) and 19.6 g of dimethylolpropionic acid were weighed under nitrogen atmosphere into a dry 2 l reaction vessel with stirring, cooling and heating equipment. 6.70 g of trimethylol propane, 225 g of acetone and 10.4 g of ethyl diisopropylamine (degree of neutralization 55%) were then added and heated to 65° C. After the addition of 66.2 g of isophorone diisocyanate and 43.3 g of hexemethylene diisocyanate, the whole was heated to reflux temperature. Heating was carried out until the theoretical NCO value was reached or fallen slightly below. After cooling to 60° C., 625 g of distilled water were added. Stirring was carried out at 40 to 50° C. until free isocyanate groups were no longer detectable. The acetone was then removed by distillation. An approx. 40% finely-divided dispersion 11) with a pH value of 7.7 and a viscosity of approx. 500 mPas/23° C. was obtained.

### Application Example 12

(According to the Invention)

Production of a Barrier Coat:

A paint for a barrier coat 12) was produced from 117 g of a pigment paste^{A)}, 195 g of dispersion 11), 9.8 g of amino-crosslinking resin (® Cymel 328, Cytec) and 8 g of distilled water. The paint had a pH value of 7.4, a solids content of 50.5% and a flow time in the ISO 5 cup of 16 seconds. After 14 days' storage of the paint at room temperature the viscosity had increased only slightly (18 seconds).

The following test results were obtained for the coating composition:

Appearance of the coating after application: In order.

Inter-layer adhesion barrier coat/top coat: (marks from 1 to 3, 1 is very good, 3 is poor): 1

Interlayer adhesion barrier coat/CEC (marks from 1 to 3, 1 is very good, 3 is poor): 1

Resistance to impact from flying stones (marks from 1 to 10, 1 is very good, 10 is very poor): 1

Testing in a repair case:

Spalling of the filler (marks from 1 to 7, 1 is very good, 7 is very poor): 1

Resistance to impact from flying stones (marks from 1 to 10, 1 is very good, 10 very poor): 1

Water resistance of the barrier coat: 1

In order to check the film hardness and the partial solubility, a film with 20 μm dry film thickness was applied, dried for 5 minutes at 80° C. and stoved for 22 minutes at 145° C.:

Film hardness: 53 pendulum seconds (per König)

Solvent resistance (testing of partial solubility after one minute loading with X/Y/Z/W,

Rating from 0 to 5, 0 is unchanged, 5 is dissolved: 2/2/2/2

Dispersion 11) meets all the requirements.

### Example 13

(According to the Invention)

272 g of an aliphatic polycarbonate diol (Desmophen® 2020, Bayer AG, molecular weight 2000), 272 g of a polyester diol based on adipic acid, hexane diol and neopentyl glycol (molecular weight 1700) and 26.8 g of dimethylolpropionic acid were weighed under nitrogen atmosphere into a dry 2 l reaction vessel with stirring, cooling and heating equipment. 11.3 g of trimethylol propane, 250 g of acetone, 106.6 g of isophorone diisocyanate and 75.9 g of hexamethylene diisocyanate and 0.025% of dibutyltin dilaurate were then added and heated to reflux temperature. Heating was carried out until the theoretical NCO value was reached or fallen slightly below. After cooling to 45° C., 17.2 g of triethylamine (degree of neutralization 85%) and thereafter 1250 g of distilled water were added. Stirring was carried out at 40 to 50° C. until free isocyanate groups were no longer detectable. The acetone was then removed by distillation. An approx. 38% very finely-divided dispersion 13) with a pH value of 7.7 and a viscosity of approx. 7500 mPas/23° C. was obtained.

### Example 14

(According to the Invention)

Production of a Barrier Coat:

A paint for a barrier coat 10) was produced from 117 g of a pigment paste A), 209 g of the dispersion 13), 9.8 g of amino-crosslinking resin (Cymel® 328, Cytec) and 8 g of distilled water. The paint had a pH value of 7.5, a solids content of approx. 49% and a flow time in the ISO 5 cup of 15 seconds. After 14 days' storage of the paint at room temperature the viscosity had increased only slightly (17 seconds).

The following test results were obtained for the coating composition:

Appearance of the coating after application: In order.

Inter-layer adhesion barrier coat/top coat: (marks from 1 to 3, 1 is very good, 3 is poor): 1

Interlayer adhesion barrier coat/CEC (marks from 1 to 3, 1 is very good, 3 is poor): 1

Resistance to impact from flying stones (marks from 1 to 10, 1 is very good, 10 is very poor): 1

Testing in a repair case:

Spalling of the filler (marks from 1 to 7, 1 is very good, 7 is very poor): 1

Resistance to impact from flying stones (marks from 1 to 10, 1 is very good, 10 very poor): 1

Water resistance of the barrier coat: 1

In order to check the film hardness and the partial solubility, a film with 20 μm dry film thickness was applied, dried for 5 minutes at 80° C. and stoved for 22 minutes at 145° C.:

Film hardness: 41 pendulum seconds (per König)

Solvent resistance: 2/2/2/3

Dispersion 13) meets all the requirements, however because of the reduced content of dimethylolpropionic acid the film hardness is in the lower range of the acceptable values.

Although the invention has been described in detail in the foregoing for the purpose of illustration, it is to be understood that such detail is solely for that purpose and that variations can be made therein by those skilled in the art without departing from the spirit and scope of the invention except as it may be limited by the claims.

What is claimed is:

1. An aqueous polyurethane dispersion wherein the polyurethane comprises the reaction product of
A) an at least difunctional polyol having a number average molecular weight of 500 to 6000,
B) an at least difunctional low molecular weight alcohol,
C) a di- and/or trifunctional isocyanate and
D) a compounds having at least one acid group and one or two hydroxy- and/or primary or secondary amino groups in an amount sufficient to provide an acid number, based on resin solids, of <25 mg KOH/g of substance,
wherein
i) the neutralizing agent is added in an amount sufficient to neutralize 40 to 105% of the acid groups and an amount sufficient to neutralize at least 40% of the acid groups is added prior to the chain extension reaction,
ii) at least 1 wt. % of components A) and B), based on the total weight of components A) to D), are tri- or higher-functional compounds and
iii) the polyurethane contains 1 to 4 wt. % of the urea groups set forth in brackets in the following formula:

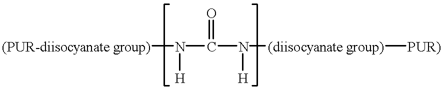

2. The aqueous polyurethane dispersion of claim 1 wherein the polyurethane comprises the reaction product of
A) 50 to 80 wt. % of an at least difunctional aliphatic polyester, polyester carbonate and/or polycarbonate polyol having a number average molecular weight of 840 to 2600,
B) 0.5 to 4 wt. % of an at least difunctional, low molecular weight alcohol having a number average molecular weight of 62 to 400,
C) 18 to 38 wt. % of an at least one di- and/or trifunctional isocyanate,
D) 2.5 to 6 wt. % of dimethylol propionic acid, dimethylol butyric acid and/or hydroxypivalic acid and
E) less than 4% by wt. of a nonionic-hydrophilic, monofunctional polyether having a number average molecular weight of 350 to 2500.

3. The aqueous polyurethane dispersion of claim 1 wherein the polyurethane comprises the reaction product of
A) 55 to 75 wt. % of a mixture of 20 to 80 wt. % of an aliphatic polyester diol having a number average molecular weight of 840 to 2100 and 20 to 80 wt. % of an aliphatic polycarbonate diol or polyester carbonate diol having a number average molecular weight of 1000 to 2100,
B) 1 to 3 wt. % of a trifunctional, low molecular weight alcohol,
C) 20 to 35 wt. % of isophorone diisocyanate and/or hexamethylene diisocyanate, or a mixture of 4,4′-diisocyanatodicyclohexyl-methane with isophorone diisocyanate or hexamethylene diisocyanate and
D) 3.5 to 4.9 wt. % of dimethylol propionic acid.

4. The aqueous polyurethane dispersion of claim 1 wherein the polyurethane comprises the reaction product of
A) 55 to 75 wt. % of an aliphatic polyester diol prepared from adipic acid, hexanediol and neopentyl glycol and having a number average molecular weight of 1700 to 2100,
B) 1 to 3 wt. % of a trifunctional, low molecular weight alcohol,
C) 20 to 35 wt. % of isophorone diisocyanate and/or hexamethylene diisocyanate, or a mixture of 4,4′-diisocyanatodicyclohexyl-methane with isophorone diisocyanate or hexamethylene diisocyanate and
D) 3.5 to 4.9 wt. % of dimethylol propionic acid.

5. The aqueous polyurethane dispersion of claim 1 wherein the tri- or higher-functional raw materials are obtained exclusively from component B).

6. The aqueous polyurethane dispersion of claim 1 wherein the number average molecular weight (Mn) of the polyurethane is >30,000 g/mole.

7. The aqueous polyurethane dispersion of claim 1 wherein the aqueous polyurethane dispersion is solvent-free, the acid number, based on solids, is <20 mg KOH/g substance and the number average molecular weight (Mn) of the polyurethane is >30,000 g/mole.

8. A process for preparing a polyurethane dispersion which comprises forming an isocyanate- and acid-functional polyurethane by reacting
I) A) an at least difunctional polyol having a number average molecular weight of 500 to 6000,
B) an at least difunctional low molecular weight alcohol,
C) a di- and/or trifunctional isocyanate and
D) a compounds having at least one acid group and one or two hydroxy- and/or primary or secondary amino groups in an amount sufficient to provide an acid number, based on resin solids, of <25 mg KOH/g of substance,
II) subsequently adding a neutralizing agent in an amount sufficient to neutralize 40 to 105% of the acid groups and dispersing the prepolymer in water,
III) optionally adding additional neutralizing agent in an amount sufficient to neutralize 105% of the acid groups,
IV) subsequently chain extending said prepolymer in water at 25 to 75° C. and
V) removing any organic solvent during or after formation of the dispersion or during or after the chain extension reaction until the amount of organic solvent is less than 5%, based on the weight of the aqueous dispersion.

9. A process for preparing a polyurethane dispersion which comprises forming an isocyanate- and acid-functional polyurethane by reacting
I) A) an at least difunctional polyol having a number average molecular weight of 500 to 6000,
B) an at least difunctional low molecular weight alcohol, and
D) a compounds having at least one acid group and one or two hydroxy- and/or primary or secondary amino groups in an amount sufficient to provide an acid number, based on resin solids, of <25 mg KOH/g of substance, in the presence of a neutralizing agent in an amount sufficient to neutralize 40 to 105% of the acid groups with
C) a di- and/or trifunctional isocyanate, and
II) dispersing the resulting prepolymer in water,
III) optionally adding additional neutralizing agent in an amount sufficient to neutralize 105% of the acid groups,
IV) subsequently chain extending said prepolymer in water at 25° C. to 75° C. and
V) removing any organic solvent during or after formation of the dispersion or during or after the chain extension reaction until the amount of organic solvent is less then 5%, based on the weight of the aqueous dispersion.

10. A coating composition comprising
a) 30 to 90 wt. % of a polyurethane dispersion wherein the polyurethane comprises the reaction product of
A) an at least difunctional polyol having a number average molecular weight of 500 to 6000,
B) an at least difunctional low molecular weight alcohol,
C) a di- and/or trifunctional isocyanate and
D) a compounds having at least one acid group and one or two hydroxy- and/or primary or secondary amino groups in an amount sufficient to provide an acid number, based on resin solids, of <25 mg KOH/g of substance,
wherein
i) the neutralizing agent is added in an amount sufficient to neutralize 60 to 105% of the acid groups and an amount sufficient to neutralize at least 60% of the acid groups is added prior to the chain extension reaction,
ii) at least 1 wt. % of components A) and B), based on the total weight of components A) to D), are tri- or higher-functional compounds and
iii) the polyurethane contains 1 to 4 wt. % of the urea groups set forth in brackets in the following formula: 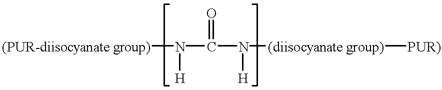
b) 0 to 20 wt. % of a crosslinking agent,
c) 5 to 70 wt. % of a pigment and/or filler,
d) 0 to 65 wt. % of a binder other than a).

11. The coating composition of claim 10 which comprises 45 to 75 wt. % of polyurethane dispersion a), 1 to 10 wt. % of crosslinking agent b), 10 to 44 wt. % of a pigment and/or filler c), and 10 to 44 wt. % of an aqueous polyester or polyester-polyurethane solution or dispersion d).

12. The coating composition of claim 10 wherein the crosslinking agent b) comprises a melamine resin, blocked polyisocyanate and/or a trisalkoxy-carbonylaminotriazine.

13. The coating composition of claim 10 which contains less than 2.5 wt. % of organic solvent, based on the weight of the coating composition, and crosslinking agent b) comprises a melamine resin and binder d) comprises a water dispersible polyester resin.

14. A coating composition which is suitable for the preparation of light fast, naturally rapidly drying coatings with very good water resistance and hardness which comprises the aqueous polyurethane resin of claim 1, a water dispersible melamine resin, a hydrophilic polyisocyanate and/or a polyester or polyester polyurethane.
